(19) United States
(12) Patent Application Publication
(10) Pub. No.: US 2026/0001081 A1
(43) Pub. Date: Jan. 1, 2026

(54) DEVICE FOR PREVENTING PULP SPILLS OR LEAKS FROM THE INSIDE OF MILLS, WITH A SHOCK ABSORBER

(71) Applicant: Alvaro Enrique ENDO ARRIAGADA, Santiago (CL)

(72) Inventor: Alvaro Enrique ENDO ARRIAGADA, Santiago (CL)

(21) Appl. No.: 19/132,060

(22) PCT Filed: Nov. 23, 2023
(86) PCT No.: PCT/CL2023/050114

§ 371 Date: May 22, 2025

(30) Foreign Application Priority Data
Nov. 24, 2022 (CL) 3318-2022

(51) Int. Cl. B02C 17/22; F16B 39/24; F16B 39/34

(52) U.S. Cl. CPC B02C 17/22; F16B 39/24; F16B 39/34

(57) ABSTRACT

The present invention relates to a device for preventing pulp spills or leaks from the inside of mills that prevents the looseness of the fastening bolts of mill claddings and prevents the elements of the device from being launched at a high speed in the event of release or sudden failure of any of its parts. This makes it possible to maintain the tension of the fastening bolt of claddings for greater elongation between the head of the bolt in contact with the cladding and the fastening nut for fastening the bolt to the mill, further reducing the risk of accident in the event of failure.

### TECHNICAL FIELD

The present invention relates to the field of fastening linings in mining mills, specifically to a device for preventing spillage or leakage of pulp from inside mills, preventing the loosening of mill lining fastening bolts, and preventing the elements of the device from being ejected at high speed in the event of sudden release or failure of any of its parts, thus maintaining the tension of the lining fastening bolt for greater elongation between the bolt head in contact with the lining and the nut securing the bolt to the mill, thereby also reducing the risk of accidents in the event of a failure.

### DESCRIPTION OF THE PRIOR ART

The mills are equipped with inner linings, which are fixed by bolts inserted into holes in the linings and in the shells and covers of the mills, where one end of the bolt secures the lining and the other end is secured to the mill by a nut that locks and tensions the bolt. In addition, a cup seal is used to prevent material from leaking from the inside to the outside of the mill.

Due to the operation of the mill, part tolerances, roughness, and characteristics of the materials that compose them, parts become loose and the tension of the lining bolts is lost, causing the seal to fail and creating a risk of material spillage or leakage that can compromise the availability of the mill and damage key elements such as the drive system and its supports. In addition, looseness can cause the bolts to shear and/or generate an irregular increase in the size of the holes in the mill shell or covers where the bolts are inserted to secure the liners.

The standard method used by the mining industry to prevent loosening is to torque the nuts to obtain an initial bolt tension of between 50% and 75% of the yield strength, and in some cases repeat this operation a few hours or days after the liners have been installed. Despite this, the problem is not completely eliminated, as the bolt only elongates by a maximum of 0.2% of its length at these high stress levels; for example, the elongation is only 1 mm for 500 mm long bolts. Despite efforts by the mining industry to control this problem, it is common to lose around 40 hours of mill operation per year due to leaks and bolt breakage, in addition to incidents that compromise key mill components.

A conventional way to increase the elongation range between the end subject to the lining and the nut is by using pressure washers. However, this solution is not practical, as the size of the pressure washers is limited by the size of the bolt, and to obtain acceptable forces and elongation percentages to hold mill linings, several pressure washers would have to be used in series, which would mean an increase in the dimension by which the bolt protrudes from the mill shell, which obviously leads to a deterioration in safety around the mill, possible interference with structures and other elements, and a significant increase in the length of the bolt. Additionally, leaks may occur between the pressure washers and the bolts, causing spills and limiting the elastic action of the washers.

In the prior art, related documents can be found that seek to increase the elongation range of the bolt and maintain the seal from inside the mill or similar devices.

In this regard, document US4371120 A discloses a particle crusher that includes a container having at least one opening in a wall thereof, where an elongated fastening device passing through said opening secures an insulating layer to the container. The fastening device includes a bolt, a nut threaded onto the bolt, and an annular elastic gasket provided to form a seal between the container and a sleeve that serves as a spacer between the outer wall of the container and an elongated fastening device or elastic means, such as concave or convex Belleville washers.

Another document to consider is US2915152 A, which discloses a device for use in the construction of structures, such as containers or tanks for storing liquids, formed by plates or sections that are bolted together to form a complete unit. In particular, it describes a bolt assembly for joining plates or sections that form a structure containing a liquid, which has features to prevent fluid leakage through the bolt connecting the plate or section assemblies. The bolt assembly includes a bolt that has an elongated head at one end and the opposite end threaded to receive a fastening nut, where said bolt passes through two sections or plates that form part of the structure of a tank, container, or any structure that is constructed by a plurality of sections; a cylindrical sleeve formed by a cylinder that includes an axial opening through which the bolt passes; an annular flange at one end of the cylinder; and a groove inside the cylinder to house an inner seal, where the cylinder and the groove are located inside the openings of the sections or plates.

Document US8454290B2 may also be considered, which discloses a fastening assembly for securing components that are placed or installed within a channel or opening formed through a workpiece component that must be secured and insulated from another component through the fastening assembly. The fastening assembly uses an insulating element that includes a metal core formed integrally with a rubber coating. This insulating element is configured to be placed between a flange and the workpiece, including a central opening through which a bolt passes to secure the workpiece by means of a nut. The insulating element described replaces traditional washers or rubber collars placed between flanges and workpieces, plates, or similar elements. The document describes that the metal core can be of various types, including a corrugated washer, a Belleville washer, or a corrugated Belleville washer.

Finally, the closest prior art document corresponds to document CL201503138, developed by the same inventor of the present application, which discloses a device (4) for preventing spillage from the interior of mining mills that maintains the seal on fastening bolts (6) of linings (1) in the mantle (2) of mills, allowing greater elongation between the head (7) of the fastening bolt (6) and its nut (5) by exerting pressure on a collar (3), where one end of the bolt (6) secures the linings (1) and the other end is secured to the mill body by means of the nut (5) that locks the bolt (6), and the washer (3) has a seal located between the mill body and the nut (5) to prevent material leakage, wherein the device comprises: one or more pairs of Belleville washers (9, 11), in whose annular space a sleeve (12) with an inner seal housing (8) is installed; where the sleeve (12) has a flange (12A) or flange with a diameter to allow the action of the nut (5) on the Belleville washers (9, 11), wherein said Belleville washers (9, 11) are assembled in series around their outer perimeter by a perimeter seal (10), wherein the device is arranged between the washer (3) and the nut (5) of the fastening bolts (6).

These documents describe options for bolt configurations designed to prevent fluid or material from passing or leaking from the interior of a mill or similar device to the exterior through the holes or perforations where bolts are installed or inserted, where, in addition, the device described in document CL201503138 allows the elongation range of the fastening bolt assembly between the end attached to the lining and the nut on the outside of the mill body to be increased while maintaining the tension exerted by the bolt at an acceptable level, maintaining the seal against leaks, and preventing spills and bolt breakage.

In this regard, it has been identified that in the devices or assemblies described in these documents, particularly those used in mills, there is a risk that, during operation, these or some of their components may become loose or fail and may be projected at high speed, with the possibility of accidents due to impact with any operator in the vicinity or damage to other equipment, devices, and/or apparatus that are mounted or being used in the same operation.

In this regard, none of these documents addresses the problem of the risk of accidents due to the high-speed projection of elements of the devices or sets of fastening bolts in the event of a sudden release or failure of any of their parts.

Thus, the prior art documents do not teach or suggest a device for preventing spillage from inside mining mills that maintains the seal on mill lining fastening bolts, which includes a shock absorber that prevents the device elements from being projected at high speed in the event of a sudden release or failure of any of its parts and which also allows for greater elongation between the bolt head and its nut by exerting pressure on a washer, increasing the range in which the bolt exerts acceptable tension for fastening linings, maintaining the seal against leaks or spills from inside the mill, thus avoiding compromising the availability of the mill and damaging key elements thereof.

### DESCRIPTION OF THE INVENTION

The invention discloses a device for preventing spillage from inside mining mills that maintains the seal on mill lining fastening bolts, which includes a cushioning element that prevents the elements of the device from being projected at high speed in the event of sudden release or failure of any of its parts, thus reducing the risk of accidents.

The device for preventing spillage from inside mining mills that maintains the seal on mill lining fastening bolts allows for greater elongation between the bolt head and its nut by exerting pressure on a sealing element while preventing the device components from being ejected at high speed in the event of sudden release or failure of any of its parts. The bolt is arranged so that one end secures the lining and the other end is secured to the mill shell by means of the nut that locks the bolt.

The device comprises at least one pair of Belleville washers or disc springs, in the annular space of which a damping element is installed between the at least one sealing element and the nut of the fastening bolts, where one end of the damping element projects onto the at least one pair of Belleville washers in the form of a flange or flange with a diameter that allows the nut to act on said washer. The shock-absorbing element has a sliding configuration of components that allows relative movement between them so that the total length of the shock-absorbing element varies in a way that favors an increase in the elongation range between the head of the fastening bolt and its nut, while compressing the at least one pair of Belleville washers and the at least one sealing element, wherein the configuration of components of the damping element allows an interior space to be defined which is filled with a viscous fluid whose position varies when the damping element is in operation, opposing movement, said resistance being of the damping type, that is, it is greater when the relative speed between the components of the damping element is greater. This resistance to movement reduces the speed at which the device components are projected in the event of a sudden release or failure of any of its parts.

### BRIEF DESCRIPTION OF THE FIGURES

FIG. 1 shows a schematic representation of the location of a device to prevent spillage from inside mining mills that maintains the seal on mill lining fastening bolts, in accordance with the state of the art currently used and described in document CL201503138.

FIG. 2A shows detail 1 of FIG. 1, in which the device currently in use is in a compressed position.

FIG. 2B shows detail 1 of FIG. 1, in which the device currently in use is in an expanded position.

FIG. 3 shows a side profile view, in section, of the device currently in use.

FIG. 4 shows a side profile view, in section, of the new device for preventing spillage from the interior of mining mills and preventing the elements of the device from being projected at high speed in the event of a sudden release or failure of any of its parts, which has a retaining bolt inserted between a sealing element and a nut, in accordance with one embodiment of the invention.

FIG. 5 shows a side profile view, in section, of the new device, according to one embodiment of the invention.

FIG. 6 shows an exploded side profile view of the new device, according to one embodiment of the invention.

### DETAILED DESCRIPTION OF THE INVENTION

The present invention relates to a device (4′) for preventing spillage from the interior of mining mills, which maintains the seal on fastening bolts (6) of linings (1) in the mantle (2) of mills, which includes a shock absorber (13) that prevents the elements of the device (4′) from being projected at high speed in the event of a sudden release or failure of any of its parts, thus reducing the risk of accidents.

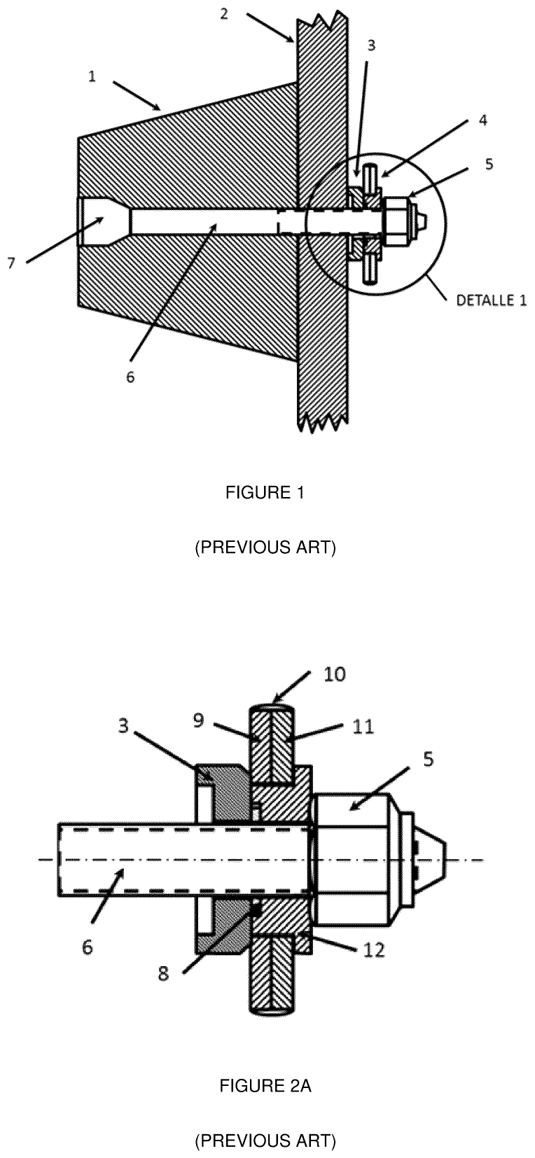

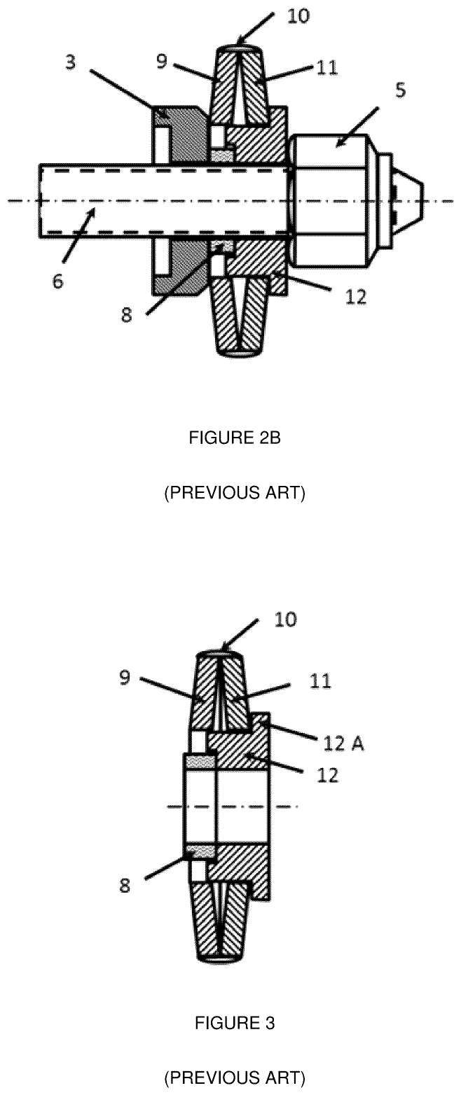

FIG. 1 shows a device (4) for preventing spillage from the interior of mining mills, in accordance with the prior art, which presents a potential risk of accidents because it has been observed that, during use, in the event of a sudden failure or release of any of its parts, said parts may be projected at high speed and could impact people in the area or other equipment. This device (4), as shown in FIGS. 2A and 2B, allows the seal to be maintained on the fastening bolts (6) of the linings (1) in the mantle (2) of the mills, allowing greater elongation between the head (7) of the fastening bolt (6) and its nut (5), exerting pressure on a washer (3), where one end of the bolt (6) secures the linings (1) and the other end is secured to the mill body by means of the nut (5) that locks the bolt (6). In addition, the washer (3) has a seal located between the mill body and the nut (5) to prevent material leakage, where the device comprises one or more pairs of Belleville washers (9, 11), in whose annular space a sleeve (12) is installed with a housing for an inner seal (8) that prevents leaks from inside the mill when the device is compressed or expanded, where the sleeve (12), as shown in FIG. 3, has a flange (12A) or a flange with a diameter to allow the action of the nut (5) on the Belleville washers (9, 11), where the device is arranged between the washer (3) and the nut (5) of the fastening bolts (6).

FIGS. 2A and 2B show the arrangement of the elements of the device (4) when it is in a compressed and expanded state, respectively. In FIG. 2A, the device (4) is in a compressed state, where the inner seal (8), made of sponge rubber or another elastomer, prevents leaks from inside the mill, being housed in the jacket (12), which allows the Belleville washers (9, 11) to be centered and compressed. In FIG. 2B, the device (4) is in an expanded state, such that the distance between the head (7) of the fastening bolt (6) and its nut (5) is maximum, for a state of tension of the fastening bolt (6). In both states, the device (4) prevents leaks from inside the mill.

The Belleville washers (9, 11) of the device (4) can be arranged in series, facing each other with their concave faces. In addition, these Belleville washers (9, 11) can be joined and sealed together around their outer perimeter using a perimeter seal (10) made of a natural or synthetic elastomer.

The device (4) works by increasing the elongation range between the head (7) of the fastening bolt (6) and its nut (5), maintaining a level of tension in the bolt (6) that prevents spillage from the bolt housing (6) into the shell (2) of the mill and loosening of the bolt (6) from the lining (1). This device (4) increases by at least 5 mm the range in which the fastening bolt (6) exerts acceptable tension for fixing the linings (1) and maintains the seal against leaks from inside the mill, thereby preventing spills, protecting key components, and avoiding mill downtime.

Despite the aforementioned benefits and as noted above, the use of this device (4) has the disadvantage that, during the operation of a mill in which the linings (1) are fixed with said device (4), there is a risk that some of its components may become loose or fail, in particular the sleeve which could be projected at high speed, with the possibility of accidents due to impact with any operator in the vicinity or damage to other equipment, devices, and/or apparatus that are mounted or being used in the same operation.

In order to reduce the risk of accidents in the event of device failure (4), in accordance with the prior art, the present application provides a new device (4′) that maintains the same benefits as device (4) of the prior art, preventing spills from inside mining mills by maintaining the seal on fastening bolts (6) of linings (1) in the mantle (2) of mills, allowing greater elongation between the head (7) of the fastening bolt (6) and its nut (5) exerting pressure on at least one sealing element (14), wherein, in addition, the new device (4′) prevents its elements or components from being projected at high speed in the event of sudden release or failure of any of its parts. The fastening bolt (6) is arranged so that one end holds the lining (1) and the other end is held to the shell (2) of the mill by means of the nut (5) that locks the fastening bolt (6).

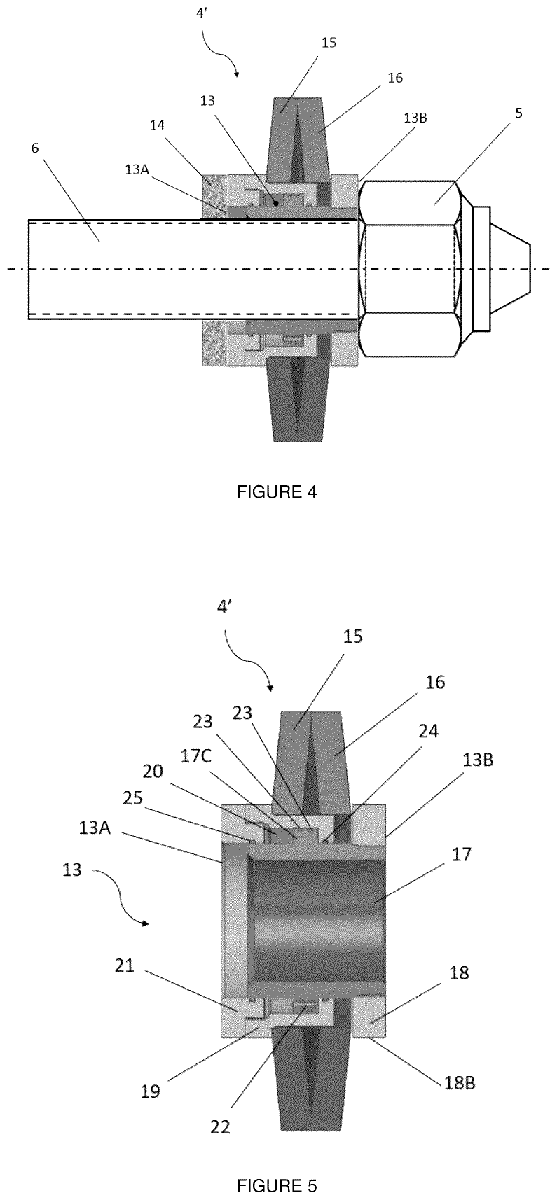

The new device (4′) comprises at least one pair of Belleville washers (15, 16) or disc springs, in the annular space of which a cylindrical damping element (13) is installed, with an inner opening for inserting the fastening bolt (6), with an inner end (13A) and an outer end (13B), arranged between the at least one sealing element (14) on the shell (2) of a mill and the nut (5) of a fastening bolt (6), as shown in FIG. 4. The new device (4′) is arranged between said elements so that the inner end (13A) of the damping element (13) is in contact with the at least one sealing element (14) and the outer end (13B) of the damping element (13) projects onto the at least one pair of Belleville washers (15, 16), having a flange shape (18B) or a diameter that allows the nut (5) to act on said Belleville washers (15, 16). The shock absorber element (13) has a sliding configuration of components that allows relative movement between them so that the total length of the shock absorber element (13) is variable, favoring an increase in the elongation range between the head (7) of the fastening bolt (6) and its nut (5), while compressing the at least one pair of Belleville washers (15, 16) and the at least one sealing element (14), where the configuration of the components of the damping element (13) allows an interior space (20) to be defined which is filled with a viscous fluid whose position varies when the damping element (13) is in operation with the mill, opposing movement, this resistance being of the damping type, i.e., it is greater when the relative speed between the components of the damping element (13) is greater. This resistance to movement allows the speed at which the elements of the new device (4′) are projected to be reduced in the event of a sudden release or failure of any of its parts.

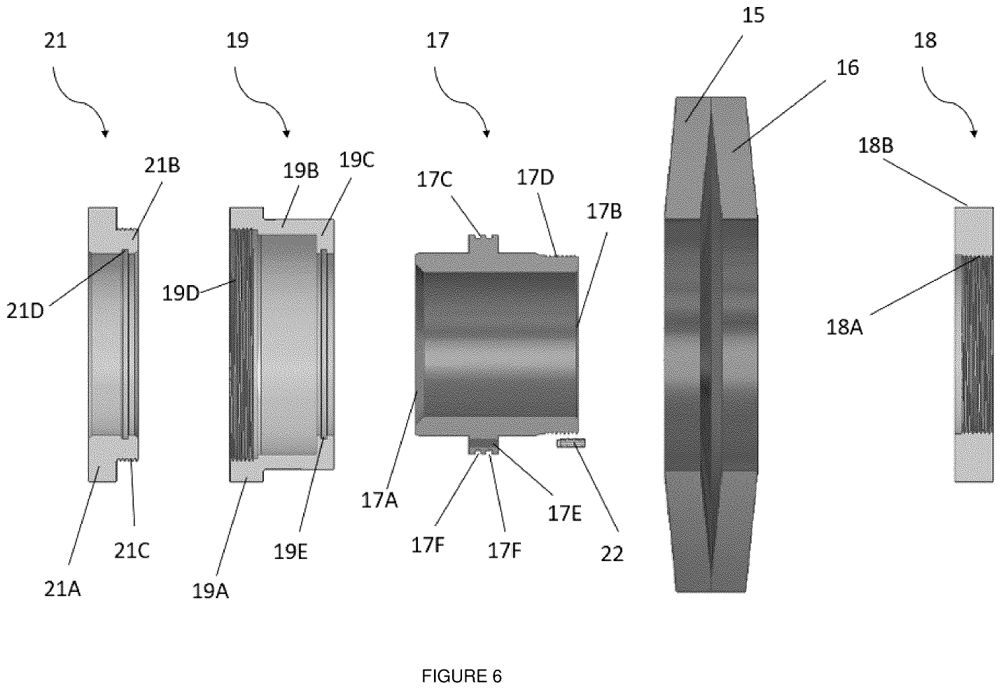

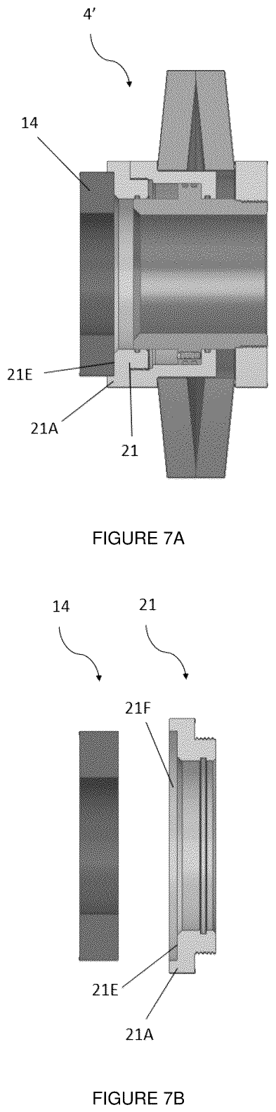

In one embodiment of the invention, as shown in FIGS. 5 and 6, the damping element (13) comprises
a male cylinder (17) with an internal opening into which the fastening bolt (6) is inserted, with an inner end (17A) and an outer end (17B), the outer wall of which comprises an annular projection (17C), such that the major diameter of said male cylinder (17) is smaller than the interior space of the at least one pair of Belleville washers (15, 16), wherein the outer wall at the outer end (17B) is threaded, forming a male thread (17D);
a male cylinder stop (18), with an interior opening, whose inner diameter coincides with the outer diameter of the outer end (17B) of the male cylinder (17), where the inner wall of the male cylinder stop (18) is threaded, forming a female thread (18A) to engage with the male thread (17D) of the male cylinder (17), wherein the outer diameter of the male cylinder stop (18) is at least greater than the diameter of the inner space of the at least one pair of Belleville washers (15, 16) so that the male cylinder stop (18) projects over the at least one pair of Belleville washers (15, 16), wherein its outer edge defines the flange (18B) or collar of the damping element (13) with a diameter that allows the nut (5) to act on said Belleville washers (15, 16);
a female cylinder (19), with an inner opening, slidably mounted on the male cylinder (17) to compress the at least one pair of Belleville washers (15, 16) together with the male cylinder stop (18), comprising an inner end (19A) with an inner diameter greater than the outer diameter of the annular projection (17C) of the male cylinder (17) and an outer diameter that is at least greater than the diameter of the inner space of the at least one pair of Belleville washers (15, 16) so that the at least one pair of Belleville washers (15, 16) are supported on the inner end (19A), a body (19B) with an inner diameter that coincides with the outer diameter of the annular projection (17C) of the male cylinder (17), forming a sliding surface between said body (19B) and the annular projection (17C), and an outer end (19C) with an inner diameter that coincides with the diameter of the outer wall of the male cylinder (17) and an outer diameter smaller than the outer diameter of the inner end (19A), so that a sliding surface is formed between the outer end (19C) and the male cylinder (17), said outer end (19C) being confined between the annular projection (17C) and the male cylinder stop (18), defining the stroke of the female cylinder (19), where the inner end (19A) and the body (19B) define an inner space (20) between the female cylinder (19) and the male cylinder (17), and where the outer wall at the inner end (19A) is threaded, constituting a female thread (19D); and
a female cylinder stop (21), with an inner opening, screwed into the inner end (19A) of the female cylinder (19) that maintains the tightness of the inner space (20) between the male cylinder (17) and the female cylinder (19), having an inner diameter that matches the diameter of the outer wall of the male cylinder (17), forming a sliding surface; wherein the annular projection (17C) of the male cylinder (17) separates the inner space (20) into two cavities, defined between the female cylinder stop (21) and the annular projection (17C), and between the annular projection (17C) and the male cylinder stop (18), the interior space (20) being filled with a viscous fluid which, when the position of the female cylinder (19) varies, passes from one side to the other between the cavities of the interior space (20) through a through-hole (17E) in the annular projection (17C), so that the passage of the fluid through the perforation (17E) opposes resistance to the relative movement between the female cylinder (19) and the male cylinder (17), said resistance being of a damping type, that is, it is greater when the relative speed between the components of the damping element (13) is greater.

In one embodiment, the male cylinder stop (18) has a length greater than or equal to the extension of the male thread (17D) of the male cylinder (17).

In one embodiment, the female cylinder (19) has a stepped configuration, comprising an inner section that defines an inner end (19A) with an inner diameter greater than the outer diameter of the annular projection (17C) of the male cylinder (17) and an outer diameter that is at least greater than the diameter of the inner space of the at least one pair of Belleville washers (15, 16) so that the at least one pair of Belleville washers (15, 16) rest on the inner end (19A); a middle section defining a body (19B) with an inner diameter that matches the outer diameter of the annular projection (17C) of the male cylinder (17) and an outer diameter that is smaller than the inner space of the at least one pair of Belleville washers (15, 16) so that a sliding surface is formed between the body (19B) and the annular projection (17C) and a sliding surface between the body (19B) and the inner space of the Belleville washers (15, 16). and a sliding surface between the body (19B) and the interior space of the Belleville washers (15, 16); and an outer section defining an outer end (19C) with an inner diameter matching the diameter of the outer wall of the male cylinder (17) and an outer diameter matching the diameter of the body (19B) so that a sliding surface is formed between the outer end (19C) and the male cylinder (17) and a sliding surface between the outer end (19C) and the interior space of the Belleville washers (15, 16), wherein the outer end (19C) is confined between the annular projection (17C) and the male cylinder stop (18), defining the stroke of the female cylinder (19). The inner diameter of the inner end (19A) and the body (19B) of the female cylinder (19) define an inner space (20) between said female cylinder and the outer wall of the male cylinder (17).

In one embodiment, the female cylinder stop (21) is flanged or stepped cylindrical in shape, comprising an inner end (21A) having an inner diameter matching the diameter of the outer wall of the male cylinder (17) and an outer diameter matching the outer diameter of the inner end (19A) of the female cylinder (19); and an outer end (21B) with an inner diameter that matches the diameter of the outer wall of the male cylinder (17) and an outer diameter that matches the inner diameter of the inner end (19A) of the female cylinder (19), wherein the outer wall of the outer end (21B) is threaded, forming a male thread (21C) for engaging with the female thread (19D) of the inner end (19A) of the female cylinder (19).

In one embodiment, the female cylinder stop (21) comprises an inner end (21A) with a cavity (21F) for housing at least a portion of the sealing element (14) therein when the device (4′) is installed in the shell (2) of the mill, thereby promoting pressure on said sealing element (14) to prevent spillage and leakage of material from inside the mill. In this embodiment, the diameter of the sealing element (14) has a diameter that matches or is close to the diameter of the cavity (21F) so that the portion of said sealing element that remains housed inside said cavity (21F) is properly fitted to ensure sealing and prevent material from leaking from inside the mill.

In one embodiment, as shown in FIGS. 7A and 7B, the diameter of the sealing member (14) may have an outer diameter smaller than the female cylinder stop (21), wherein the inner end (21A) of said female cylinder stop (21) has a stepped interior (21E) so as to comprise a first inner diameter, adjacent to the edge of the inner end (21A), which coincides with the diameter of the sealing element, wherein said first diameter extends into the interior of the inner end (21A) so as to form a cavity (21F) for receiving at least a portion of the sealing element (14) that remains inside the female cylinder stop (21) when the device (4′) is installed in the shell (2) of the mill, thereby promoting pressure on said sealing element (14) to prevent spillage and leakage of material from inside the mill; and a second inner diameter that coincides with the diameter of the outer wall of the male cylinder (17). The diameter of the sealing element (14) may coincide with or be close to the first inner diameter or the diameter of the cavity (21F) so that at least a portion of said sealing element (14) is properly housed inside said cavity (21F).

In one embodiment, the outer diameter of the male cylinder stop (18), the outer diameter of the inner end (19A) of the female cylinder (19), and the outer diameter of the inner end (21A) of the female cylinder stop (21) are equal.

In one embodiment, the through-hole (17E) in the annular projection (17C) has a cylindrical insert (22) with an internal longitudinal hole that hinders the passage of viscous fluid between the cavities of the inner space (20) to increase the resistance to relative movement between the female cylinder (19) and the male cylinder (17), thereby enhancing the damping capacity of the damping element (13).

In one embodiment, the annular projection (17C) of the male cylinder (17) comprises external slots (17F) for placing cylindrical seals (23) that prevent the viscous fluid in the interior space (20) from passing through the sliding surfaces between the female cylinder (19) and the annular projection (17C), thereby reducing the damping capacity of the damping element (13).

In one embodiment, the diameter of the body (19B) of the female cylinder (19) is greater than the diameter of the annular projection (17C) of the male cylinder (17) by an amount within the adjustment specifications indicated for the proper functioning of the seals (23), which ensures the tightness and sliding of the female cylinder (19) on the male cylinder (17).

In one embodiment, the inner wall of the outer end (19C) of the female cylinder (19) comprises at least one groove (19E) for placing a cylindrical seal (24) that prevents the viscous fluid in the inner space (20) from passing through the sliding surfaces between the outer end (19C) and the male cylinder (17) and escaping to the outside.

In one embodiment, the inner wall of the outer end (21B) of the female cylinder stop (21) comprises at least one groove (21D) for placing a cylindrical seal (25) that prevents the viscous fluid in the inner space (20) from passing through the sliding surfaces between the female cylinder stop (21) and the male cylinder (17), escaping to the outside.

In one embodiment, the Belleville washers (15, 16) are arranged with their concave faces against the convex faces or with their concave faces against the concave faces.

In one embodiment, when the new device (4′) comprises two or more pairs of Belleville washers (15, 16), each pair is arranged so that the pairs of washers face each other with their concave faces, thereby extending the range of elongation between the head (7) of the fastening bolt (6) and its nut (5). In another embodiment, when the new device (4′) comprises two pairs of Belleville washers (15, 16), each pair is arranged so that the concave face in one pair of washers faces the convex face of the washer in the other pair, where the washers in each pair interact with each other through the concave faces.

1. A device (4′) for preventing spillage from inside mining mills, which maintains the seal on fastening bolts (6) of a lining (1) on the mantle (2) of mills, allowing greater elongation between the bolt head (7) and its nut (5) by exerting pressure on at least one sealing element (14) on the mantle (2) of the mill, and prevents its elements from being ejected at high speed in the event of sudden release or failure of any of its parts, CHARACTERIZED in that it comprises at least one pair of Belleville washers (15, 16) or disc springs, in whose annular space a damping element (13) is installed, with an inner end (13A) in contact with the at least one sealing element (14) and an outer end (13B) projecting onto the at least one pair of Belleville washers (15, 16), having a flange shape (18B) or a diameter that allows the nut (5) to act on said Belleville washers (15, 16), where the shock absorber element (13) has a sliding configuration of components that allows relative movement between them so that the total length of the shock absorber element (13) is variable, favoring an increase in the elongation range between the head (7) of the fastening bolt (6) and its nut (5), while compressing the at least one pair of Belleville washers (15, 16) and the at least one sealing element (14), wherein the damping element (13) has an interior space (20) that is filled with a viscous fluid whose position varies when the damping element (13) is in operation with the mill, opposing movement, said resistance being of the damping type, that is, it is greater when the relative speed between the components of the damping element (13) is greater.

2. The device (4′), according to claim 1, is CHARACTERIZED in that the damping element (13) comprises:
a male cylinder (17) with an inner opening into which the fastening bolt (6) is inserted, having an inner end (17A) and an outer end (17B), the outer wall of which comprises an annular projection (17C), such that the major diameter of said male cylinder (17) is smaller than the interior space of the at least one pair of Belleville washers (15, 16), wherein the outer wall at the outer end (17B) is threaded, forming a male thread (17D);
a male cylinder stop (18), with an interior opening, whose inner diameter coincides with the outer diameter of the outer end (17B) of the male cylinder (17), where the inner wall of the male cylinder stop (18) is threaded, forming a female thread (18A) to engage with the male thread (17D) of the male cylinder (17), wherein the outer diameter of the male cylinder stop (18) is at least greater than the diameter of the inner space of the at least one pair of Belleville washers (15, 16) so that the male cylinder stop (18) projects over the at least one pair of Belleville washers (15, 16), wherein its outer edge defines the flange (18B) or collar of the damping element (13) with a diameter that allows the nut (5) to act on said Belleville washers (15, 16);
a female cylinder (19), with an inner opening, slidably mounted on the male cylinder (17) to compress the at least one pair of Belleville washers (15, 16) together with the male cylinder stop (18), comprising:
an inner end (19A) with an inner diameter greater than the outer diameter of the annular projection (17C) of the male cylinder (17), where the outer wall at the inner end (19A) is threaded, forming a female thread (19D) and an outer diameter that is at least greater than the diameter of the inner space of the at least one pair of Belleville washers (15, 16) so that the at least one pair of Belleville washers (15, 16) are supported on the inner end (19A);
a body (19B) with an inner diameter that matches the outer diameter of the annular projection (17C) of the male cylinder (17), forming a sliding surface between said body (19B) and the annular projection (17C);
an outer end (19C) with an inner diameter that matches the diameter of the outer wall of the male cylinder (17) and an outer diameter smaller than the outer diameter of the inner end (19A), so that a sliding surface is formed between the outer end (19C) and the male cylinder (17), said outer end (19C) being confined between the annular projection (17C) and the male cylinder stop (18), defining the stroke of the female cylinder (19),
wherein the inner end (19A) and the body (19B) define the inner space (20) between the female cylinder (19) and the male cylinder (17); and
a female cylinder stop (21), with an inner opening, screwed into the inner end (19A) of the female cylinder (19), which maintains the tightness of the inner space (20) between the male cylinder (17) and the female cylinder (19), having an inner diameter that matches the diameter of the outer wall of the male cylinder (17) forming a sliding surface,
where the annular projection (17C) of the male cylinder (17) separates the interior space (20) into two cavities, defined between the female cylinder stop (21) and the annular projection (17C), and between the annular projection (17C) and the male cylinder stop (18), where the interior space is filled with a viscous fluid that, when the position of the female cylinder (19) varies, passes from one side to the other between the cavities of the interior space (20) through a through-hole (17E) in the annular projection (17C), so that the passage of the fluid through the perforation (17E) opposes resistance to the relative movement between the female cylinder (19) and the male cylinder (17).

3. The device (4′), according to claim 2, CHARACTERIZED in that the female cylinder (19) has a stepped configuration, comprising
an inner section defining the inner end (19A) having an inner diameter greater than the outer diameter of the annular projection (17C) of the male cylinder (17) and an outer diameter that is at least greater than the diameter of the inner space of the at least one pair of Belleville washers (15, 16) such that the at least one pair of Belleville washers (15, 16) are supported on the inner end (19A);
a middle section defining the body (19B) having an inner diameter that coincides with the outer diameter of the annular projection (17C) of the male cylinder (17) and an outer diameter smaller than the inner space of the at least one pair of Belleville washers (15, 16) so that a sliding surface is formed between the body (19B) and the annular projection (17C) and a sliding surface between the body (19B) and the interior space of the Belleville washers (15, 16); and
an outer section defining the outer end (19C) having an inner diameter coinciding with the diameter of the outer wall of the male cylinder (17) and an outer diameter coinciding with the diameter of the body (19B) so that a sliding surface is formed between the outer end (19C) and the male cylinder (17) and a sliding surface between the outer end (19C) and the interior space of the Belleville washers (15, 16), where the outer end (19C) is confined between the annular projection (17C) and the male cylinder stop (18), defining the stroke of the female cylinder (19),.
where the inner diameter of the inner end (19A) and the body (19B) of the female cylinder (19) define the inner space (20) between said female cylinder and the outer wall of the male cylinder (17).

4. The device (4′), according to claim 2, is CHARACTERIZED in that the male cylinder stop (18) has a length greater than or equal to the extension of the male thread (17D) of the male cylinder (17).

5. The device (4′), according to claim 2, CHARACTERIZED in that the female cylinder stop (21) is flange-shaped or stepped cylindrical, comprising
an inner end (21A) having an inner diameter coinciding with the diameter of the outer wall of the male cylinder (17) and an outer diameter coinciding with the outer diameter of the inner end (19A) of the female cylinder (19); and
an outer end (21B) with an inner diameter that matches the diameter of the outer wall of the male cylinder (17) and an outer diameter that matches the inner diameter of the inner end (19A) of the female cylinder (19), wherein the outer wall of the outer end (21B) is threaded, forming a male thread (21C) for engaging with the female thread (19D) of the inner end (19A) of the female cylinder (19).

6. The device (4′), according to claim 2, is CHARACTERIZED in that the through-hole (17E) in the annular projection (17C) has an insert (22) placed therein, with an internal longitudinal perforation that hinders the passage of viscous fluid between the cavities of the internal space (20) to increase resistance to relative movement between the female cylinder (19) and the male cylinder (17), favoring the damping capacity of the damping element (13).

7. The device (4′), according to claim 2, is CHARACTERIZED in that the annular projection (17C) of the male cylinder (17) comprises outer slots (17F) for placing cylindrical seals (23) that prevent the viscous fluid in the inner space (20) from passing through the sliding surfaces between the female cylinder (19) and the annular projection (17C).

8. The device (4′), according to claim 7, is CHARACTERIZED in that the diameter of the body (19B) of the female cylinder (19) is greater than the diameter of the annular projection (17C) of the male cylinder (17) by an amount within the adjustment specifications indicated for the proper functioning of the seals (23), which ensures the tightness and sliding of the female cylinder (19) on the male cylinder (17).

9. The device (4′), according to claim 2, is CHARACTERIZED in that the inner wall of the outer end (19C) of the female cylinder (19) comprises at least one slot (19E) for placing a cylindrical seal (24) that prevents the viscous fluid in the inner space (20) from passing through the sliding surfaces between the outer end (19C) and the male cylinder (17), thereby escaping to the outside.

10. The device (4′), according to claim 5, is CHARACTERIZED in that the inner wall of the outer end (21B) of the female cylinder stop (21) comprises at least one slot (21D) for placing a cylindrical seal (25) that prevents the viscous fluid in the inner space (20) from passing through the sliding surfaces between the female cylinder stop and the male cylinder (17), escaping to the outside.

11. The device (4′), according to claim 2, is CHARACTERIZED in that the Belleville washers (15, 16) are arranged concave side against convex side or concave side against concave side.

12. The device (4′), according to claim 2, is CHARACTERIZED in that it comprises two pairs of Belleville washers (15, 16), each pair being arranged so that the pairs of washers face each other with their concave faces.

13. The device (4′), according to claim 2, is CHARACTERIZED in that it comprises two or more pairs of Belleville washers (15, 16), wherein each pair is arranged such that the concave face in one pair of washers faces the convex face of the washer of the other pair, wherein the washers of each pair interact with each other through the concave faces.

14. The device (4′), according to claim 2, is CHARACTERIZED in that the female cylinder stop (21) comprises an inner end (21A) with a cavity (21F) for receiving at least a portion of the sealing element (14) therein when the device (4′) is installed in the mantle (2) of the mill.

15. A cushioning element (13) for a device (4′) to prevent spillage from the interior of mining mills, which holds the seal on fastening bolts (6) of the lining (1) on the mantle (2) of mills, allowing greater elongation between the bolt head (7) and its nut (5) by exerting pressure on at least one sealing element (14), on the mill shell (2), and prevents the elements of the device (4′) from being ejected at high speed in the event of a sudden release or failure of any of its parts, CHARACTERIZED in that it has a cylindrical shape with an inner opening for inserting the fastening bolt (6), having an inner end (13A) and an outer end (13B) with a flange (18B) shape, where the shock-absorbing element (13) has a sliding configuration of components that allows relative movement between them so that the total length of the shock-absorbing element (13) is variable, favoring an increase in the elongation range between the head (7) of the fastening bolt (6) and its nut (5), wherein the damping element (13) has an interior space (20) that is filled with a viscous fluid whose position varies when the damping element (13) is in operation, opposing movement, said resistance being of a damping type, that is, greater when the relative speed between the components of the damping element (13) is greater.

16. The shock-absorbing element (13), according to claim 15, is CHARACTERIZED in that it comprises:
a male cylinder (17), with an inner opening for inserting the fastening bolt (6), having an inner end (17A) and an outer end (17B), whose outer wall comprises an annular projection (17C), where the outer wall at the outer end (17B) is threaded, forming a male thread (17D);
a male cylinder stop (18), with an internal opening, whose internal diameter coincides with the external diameter of the external end (17B) of the male cylinder (17), where the inner wall of the male cylinder stop (18) is threaded, forming a female thread (18A) for coupling with the male thread (17D) of the male cylinder (17), where the outer diameter projects outward so that its outer edge defines the flange (18B);
a female cylinder (19), with an inner opening, slidably mounted on the male cylinder (17) to compress the at least one pair of Belleville washers (15, 16) together with the male cylinder stop (18), comprising:
an inner end (19A) with an inner diameter greater than the outer diameter of the annular projection (17C) of the male cylinder (17), where the outer wall at the inner end (19A) is threaded, forming a female thread (19D);
a body (19B) with an inner diameter that matches the outer diameter of the annular projection (17C) of the male cylinder (17), forming a sliding surface between said body (19B) and the annular projection (17C), and an outer diameter smaller than the outer diameter of the inner end (19A); and
an outer end (19C) with an inner diameter that matches the diameter of the outer wall of the male cylinder (17), so that a sliding surface is formed between the outer end (19C) and the male cylinder (17), and an outer diameter that matches the outer diameter of the body (19B), said outer end (19C) being confined between the annular projection (17C) and the male cylinder stop (18), defining the stroke of the female cylinder (19),
wherein the inner end (19A) and the body (19B) define the inner space (20) between the female cylinder (19) and the male cylinder (17); and
a female cylinder stop (21), with an inner opening, screwed into the inner end (19A) of the female cylinder (19), which maintains the tightness of the inner space (20) between the male cylinder (17) and the female cylinder (19), having an inner diameter that matches the diameter of the outer wall of the male cylinder (17) forming a sliding surface,
where the annular projection (17C) of the male cylinder (17) separates the interior space (20) into two cavities, defined between the female cylinder stop (21) and the annular projection (17C), and between the annular projection (17C) and the male cylinder stop (18), where the interior space is filled with a viscous fluid that, when the position of the female cylinder (19) varies, passes from one side to the other between the cavities of the interior space (20) through a through-hole (17E) in the annular projection (17C), so that the passage of the fluid through the perforation (17E) opposes resistance to the relative movement between the female cylinder (19) and the male cylinder (17).

17. The shock-absorbing element (13), according to claim 16, CHARACTERIZED in that the female cylinder (19) has a stepped configuration, comprising
an inner section defining the inner end (19A) having an inner diameter greater than the outer diameter of the annular projection (17C) of the male cylinder (17) and an outer diameter which is at least greater than the diameter of the inner space of a Belleville washer (15, 16);
a middle section defining the body (19B) having an inner diameter coinciding with the outer diameter of the annular projection (17C) of the male cylinder (17), forming a sliding surface between said body (19B) and the annular projection (17C), and an outer diameter smaller than the outer diameter of the inner end (19A); and
an outer section defining the outer end (19C) having an inner diameter that coincides with the diameter of the outer wall of the male cylinder (17) and an outer diameter that coincides with the diameter of the body (19B), such that a sliding surface is formed between the outer end (19C) and the male cylinder (17) and a sliding surface between the outer end (19C) and the inner space of the Belleville washers (15, 16), where the outer end (19C) is confined between the annular projection (17C) and the male cylinder stop (18), defining the stroke of the female cylinder (19),.
where the inner diameter of the inner end (19A) and the body (19B) of the female cylinder (19) define the inner space (20) between said female cylinder and the outer wall of the male cylinder (17).

18. The shock element (13), according to claim 16, is CHARACTERIZED in that the male cylinder stop (18) has a length greater than or equal to the extension of the male thread (17D) of the male cylinder (17).

19. The shock absorber element (13), according to claim 16, CHARACTERIZED in that the female cylinder stop (21) is flange-shaped or stepped cylindrical, comprising
an inner end (21A) having an inner diameter matching the diameter of the outer wall of the male cylinder (17); and
an outer end (21B) with an inner diameter that matches the diameter of the outer wall of the male cylinder (17) and an outer diameter that matches the inner diameter of the inner end (19A) of the female cylinder (19), wherein the outer wall of the outer end (21B) is threaded, forming a male thread (21C) for engaging with the female thread (19D) of the inner end (19A) of the female cylinder (19).

20. The shock absorber element (13), according to claim 16, is CHARACTERIZED in that the through-hole (17E) in the annular projection (17C) has a cylindrical insert (22) with an internal longitudinal perforation that hinders the passage of viscous fluid between the cavities of the internal space (20) to increase the resistance to relative movement between the female cylinder (19) and the male cylinder (17), favoring the damping capacity of the damping element (13).

21. The damping element (13), according to claim 16, is CHARACTERIZED in that the annular projection (17C) of the male cylinder (17) comprises external slots (17F) for placing cylindrical seals (23) that prevent the viscous fluid in the interior space (20) from passing through the sliding surfaces between the female cylinder (19) and the annular projection (17C). female cylinder (19) and the annular projection (17C).

22. The shock absorber element (13), according to claim 21, is CHARACTERIZED in that the diameter of the body (19B) of the female cylinder (19) is greater than the diameter of the annular projection (17C) of the male cylinder (17) by an amount within the adjustment specifications indicated for the proper functioning of the seals (23), which ensure the tightness and sliding of the female cylinder (19) on the male cylinder (17).

23. The shock absorber element (13), according to claim 16, is CHARACTERIZED in that the inner wall of the outer end (19C) of the female cylinder (19) comprises at least one groove (19E) for placing a cylindrical seal (24) that prevents the viscous fluid in the inner space (20) from passing through the sliding surfaces between the outer end (19C) and the male cylinder (17), thereby escaping to the outside.

24. The shock absorber (13), according to claim 16, is CHARACTERIZED in that the inner wall of the outer end (21B) of the female cylinder stop (21) comprises at least one groove (21D) for placing a cylindrical seal (25) that prevents the viscous fluid in the inner space (20) from passing through the sliding surfaces between the female cylinder stop (21) and the male cylinder (17) and escaping to the outside.

25. The damping element (13), according to claim 16, is CHARACTERIZED in that the female cylinder stop (21) comprises an inner end (21A) with a cavity (21F) for housing at least a portion of the sealing element (14) therein when the device (4′) is installed in the shell (2) of the mill.

26. The shock-absorbing element (13), according to claim 16, is CHARACTERIZED in that the female cylinder stop (21) has an inner end (21A) with a stepped interior (21E) comprising a first inner diameter, adjacent to the edge of the inner end (21A), which coincides with the diameter of the sealing element (14), wherein said first diameter extends into the interior of the inner end (21A) forming a cavity (21F) for receiving at least a portion of the sealing element (14); and a second inner diameter which coincides with the diameter of the outer wall of the male cylinder (17).
